(19) United States
(12) Patent Application Publication
(10) Pub. No.: US 2021/0159744 A1
(43) Pub. Date: May 27, 2021

(54) ROTOR INCLUDING END PLATE DISPOSED ON END FACE OF ROTOR CORE AND ELECTRIC MOTOR INCLUDING ROTOR

(71) Applicant: Fanuc Corporation, Minamitsuru-gun (JP)

(72) Inventor: Yasunori Sugimoto, Minamitsuru-gun (JP)

(73) Assignee: Fanuc Corporation, Minamitsuru-gun (JP)

(21) Appl. No.: 17/072,186

(22) Filed: Oct. 16, 2020

(30) Foreign Application Priority Data
Nov. 25, 2019 (JP) 2019-212668

(51) Int. Cl. H02K 1/27; H02K 5/15

(52) U.S. Cl. CPC H02K 1/274; H02K 5/15

(57) ABSTRACT

A rotor includes a plurality of magnets supported by a rotor core, and end plates disposed so as to sandwich end faces on both sides of the rotor core. Each of the end plates is formed of a material having magnetism. The end plate includes a cutout portion having a shape in which a surface of the end plate is away from an end face of each of the plurality of magnets. The cutout portion is formed in a region facing the magnet.

### BACKGROUND OF THE INVENTION

### 1. Field of the Invention

The present invention relates to a rotor including an end plate disposed on an end face of a rotor core and an electric motor including the rotor.

### 2. Description of the Related Art

An electric motor includes a rotor rotating about a rotation axis, and a stator disposed around the rotor. In a rotor of the related art, a structure including a shaft extending along a rotation axis, a rotor core fixed to the shaft, and a magnet fixed to the rotor core is known.

It is known that end plates are disposed on end faces on both sides in a direction in which a rotation axis of the rotor core extends. The end plates are formed so as to sandwich end faces on both sides in an axial direction of the rotor core. Such end plates are fixed by fastening members such as bolts (e.g., refer to Japanese Unexamined Patent Publication No. 2006-238531A and Japanese Unexamined Patent Publication No. 2012-120422A).

### SUMMARY OF THE INVENTION

A plurality of magnets fixed to a rotor core are disposed such that, for example, the magnetic poles of outer surfaces are alternately the N-pole and the S-pole. In order for an electric motor to rotate efficiently, preferably magnetic flux emanating from the N-pole of an outer surface of one magnet passes through a stator core of a stator toward the S-pole of another magnet. That is, a line of magnetic force is preferably directed from the outer surface of the one magnet to a surface of the other magnet via the stator core.

Here, end plates disposed on both sides in the axial direction of the rotor core are in contact with end faces of the magnets fixed to the rotor core. Alternatively, the end plates are disposed with a slight gap from the magnets. When the end plates are formed of a material having magnetism, a line of magnetic force extending from the N-pole of the one magnet passes through the end plates toward the S-pole of the same magnet. The loop of the line of magnetic force is formed by the N-pole and the S-pole of the one magnet, and there is a problem of leakage of magnetic flux. When magnetic flux leaks, magnetic force contributing to torque generated by the electric motor reduces. Further, since the loop of the line of magnetic force passing through the end plates is formed, the end plates may generate heat and cause iron loss.

Thus, in the related art, the end plates sandwiching the rotor core are formed of a material having no magnetism. For example, the end plates of a rotor are formed of stainless steel, aluminum, or the like. However, stainless steel, aluminum, or the like are more valuable materials than a material having magnetism such as iron, and there is a problem of making the rotor expensive.

A rotor according to an aspect of the present disclosure includes a rotor core rotating about a rotation axis, a plurality of magnets supported by the rotor core, and end plates disposed to sandwich end faces on both sides of the rotor core. Each of the end plates is formed of a material having magnetism. The end plate includes a retraction portion that is formed in at least a region among regions facing the plurality of magnets and that has a shape in which a surface of the end plate is away from an end face of each of the plurality of magnets. The retraction portion includes at least one of a cutout portion formed at an end portion in the radial direction of the end plate and a recess recessed from a part of the end plate being in contact with the rotor core.

An electric motor according to an aspect of the present disclosure includes the above-described rotor and a stator in which the rotor is disposed.

### BRIEF DESCRIPTION OF THE DRAWINGS

FIG. 1 is a schematic cross-sectional view of an electric motor in an embodiment taken along a plane parallel to a rotation axis.

FIG. 2 is a perspective view of a rotor core, a magnet, and an end plate of a first rotor.

FIG. 3 is an exploded perspective view of the rotor core, the magnet, and the end plate of the first rotor.

FIG. 4 is a cutaway perspective view of the rotor core, the magnet, and the end plate with a part of the first rotor.

FIG. 5 is a perspective view of the end plate of the first rotor.

FIG. 6 is an enlarged cross-sectional view of the rotor core, the magnet, and the end plates of the first rotor.

FIG. 7 is a cross-sectional view for explaining a method of manufacturing the first rotor.

FIG. 8 is a perspective view of an end plate of a second rotor in an embodiment.

FIG. 9 is an enlarged plan view of the end plate of the second rotor.

FIG. 10 is an enlarged cross-sectional view of a rotor core, a magnet, and an end plate of a third rotor in an embodiment.

FIG. 11 is a perspective view of an end plate of a fourth rotor in an embodiment.

FIG. 12 is an enlarged cross-sectional view of a rotor core, a magnet, and the end plates of the fourth rotor.

FIG. 13 is a perspective view of an end plate of a fifth rotor in an embodiment.

FIG. 14 is an enlarged plan view of the end plate of the fifth rotor.

### DETAILED DESCRIPTION

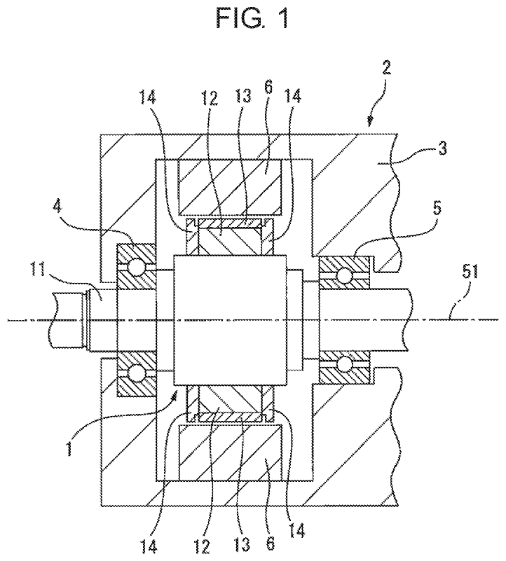

A rotor and an electric motor in embodiments will be described with reference to FIGS. 1 to 14. FIG. 1 is a schematic cross-sectional view of an electric motor including a first rotor of the present embodiment, and taken along a plane parallel to a rotation axis. An electric motor 2 of the present embodiment includes a rotor rotating around a rotation axis 51 and a stator 6 in which the rotor is disposed. In an example illustrated in FIG. 1, a first rotor 1 is disposed.

The first rotor 1 includes a shaft 11 rotating about the rotation axis 51. The shaft 11 is formed in a columnar shape. The stator 6 includes, for example, a stator core in which a plurality of electromagnetic steel sheets are laminated in a direction in which the shaft 11 extends. The stator 6 is supported by the stator core and includes a plurality of coils disposed along a circumferential direction. The stator 6 is fixed to a housing 3. The shaft 11 is supported by bearings 4, 5. The bearings 4, 5 are supported by the housing 3.

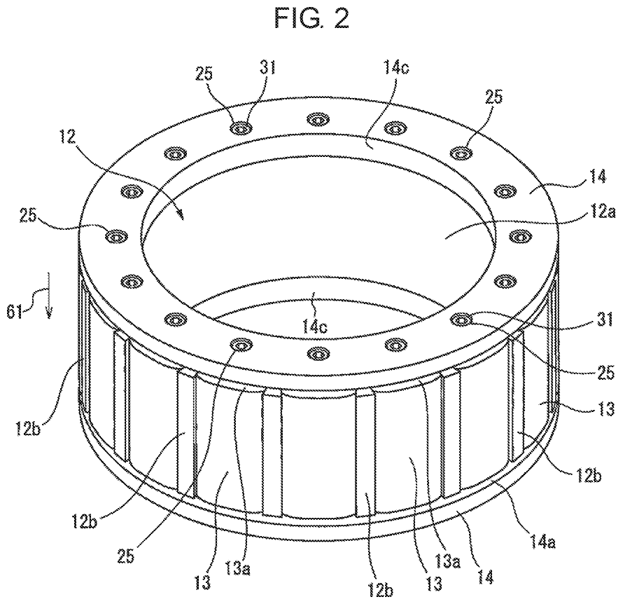

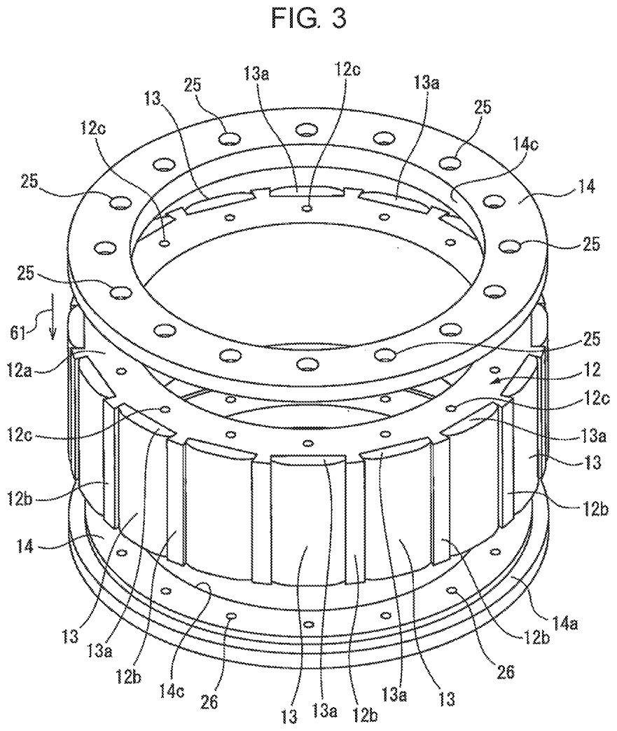

FIG. 2 illustrates a perspective view of a rotor core, a magnet, and an end plate of the first rotor of the present embodiment. FIG. 3 illustrates an exploded perspective view of the rotor core, the magnet, and the end plate of the first rotor of the present embodiment. With reference to FIGS. 1 to 3, the first rotor 1 of the present embodiment is a rotor of a surface magnet type in which a magnet 13 is disposed on a surface of a rotor core 12.

The rotor 1 includes the rotor core 12 fixed to the shaft 11. The rotor core 12 of the present embodiment includes a cylindrical portion 12a having a cylindrical shape. The rotor core 12 rotates about the rotation axis 51. The rotor core 12 of the present embodiment is formed of a single member having magnetism. For example, the rotor core 12 can be formed by cutting a member containing iron as a main component. A structure of the rotor core is not limited to this form. The rotor core may be constituted by, for example, a laminated body in which a plurality of electromagnetic steel sheets are laminated in the direction in which the rotation axis extends.

The rotor 1 includes a plurality of the magnets 13 supported by the rotor core 12. The plurality of magnets 13 are disposed on an outer circumferential surface of the rotor core 12. The magnet 13 of the present embodiment is a plate-shaped permanent magnet. The plurality of magnets 13 are disposed at regular intervals along a circumferential direction. The number of the magnets depends on the number of the poles of the rotor. Depending on the number of the poles of the rotor, any number of the magnets can be fixed to the rotor core.

The magnet 13 extends from one end to the other end in the direction in which the rotation axis 51 of the rotor core 12 extends. The length of the magnet 13 in the direction in which the rotation axis 51 extends is formed so as to be equal to or less than the length of the rotor core 12. For example, the plurality of magnets 13 are disposed such that outer surfaces repeat the N-pole and the S-pole along the circumferential direction.

The rotor core 12 includes a locking portion 12b extending along the rotation axis 51. The locking portion 12b is formed so as to project radially outward from the cylindrical portion 12a. The locking portion 12b is formed so as to extend from one end face to the other end face along the direction in which the rotation axis 51 of the rotor core 12 extends. The locking portion 12b is formed so as to be in contact with a side surface of the magnet 13. The locking portions 12b are formed so as to sandwich the magnet 13 in the circumferential direction. The magnet 13 is disposed between two locking portions 12b. The magnet 13 in the present embodiment is fixed to the rotor core 12 by an adhesive. Additionally, the magnet 13 may be fixed to the rotor core 12 by being sandwiched between the two locking portions 12b without using an adhesive. When the magnet 13 is fixed to the rotor core 12 with an adhesive, movement of the magnet 13 in the circumferential direction is suppressed by the adhesive. Thus, in the rotor core 12, the locking portions 12b sandwiching the magnet 13 may not be formed.

The rotor 1 in the present embodiment includes two end plates 14 disposed so as to sandwich end faces on both sides of the rotor core 12 in the direction in which the rotation axis 51 extends. Each of the end plates 14 is formed in an annular shape so as to correspond to a cross-sectional shape of the rotor core 12. Each of the end plates 14 includes a hole 14c for inserting the shaft 11. Note that in the present embodiment, the end plate 14 disposed in a direction indicated by an arrow 61 (lower side in FIG. 2) is referred to as one end plate, and the end plate 14 disposed in a direction opposite to the arrow 61 (upper side in FIG. 2) is referred to as the other end plate.

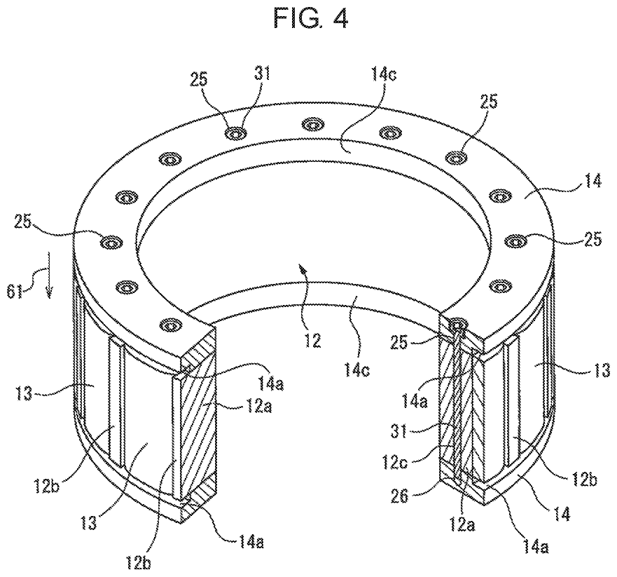

FIG. 4 illustrates a cutaway perspective view of the rotor core, the magnets, and the end plates of the first rotor in the present embodiment. With reference to FIGS. 2 to 4, the two end plates 14 are fixed to each other by a bolt 31 as a fastening member. The bolts 31 are disposed at regular intervals along the circumferential direction.

In one end plate 14 disposed on the lower side in FIGS. 2, 3 and 4, a hole 26 in which a screw thread for fixing the bolt 31 is formed is formed. A through hole 12c for inserting the bolt 31 is formed in the cylindrical portion 12a of the rotor core 12. An insertion portion 25 for supporting a head of the bolt 31 is formed in the other end plate 14 disposed on the upper side in FIGS. 2 to 4. The hole 26, the through hole 12c, and the insertion portion 25 are formed at positions communicating with each other.

A method of fixing the end plate 14 to the rotor core 12 is not limited to the method of fixing with the bolt 31, and any method can be adopted. For example, the end plate can be fixed to the rotor core by welding, bonding, shrink-fitting to an inner circumferential surface of the rotor core, or press fitting to the inner circumferential surface of the rotor core, or the like. Additionally, the rotor core may not be formed of a laminated body of electromagnetic steel sheets, but may be formed by cutting one iron member. In accordance with this case, the bolt does not need to pass through the rotor core, and a threaded hole including a bottom can be formed in the rotor core. Then, the bolt can be fixed to the threaded hole.

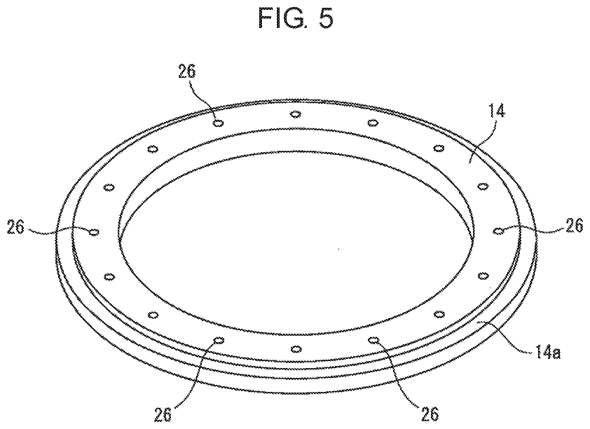

FIG. 5 illustrates a perspective view of the end plate in the present embodiment. FIG. 5 illustrates the one end plate 14 of the two end plates 14. As described above, the insertion portion 25 is formed in the other end plate 14 instead of the hole 26. The other end plate 14 includes a cutout portion 14a similar to that of the one end plate 14. Other configurations of the other end plate 14 are similar to those of the one end plate 14.

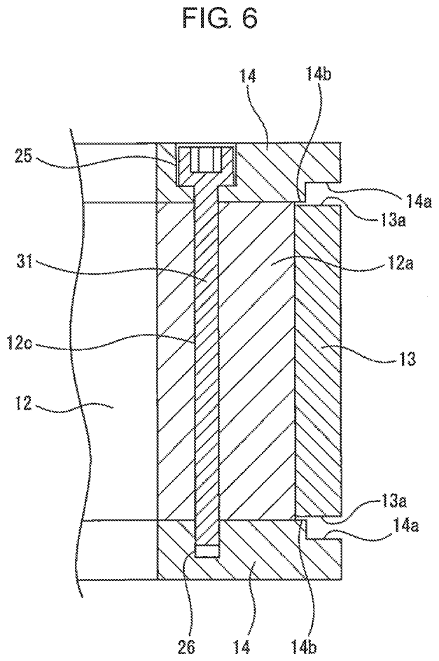

FIG. 6 illustrates an enlarged cross-sectional view of the rotor core, the magnet, and the end plate, when the first rotor is cut at a part through which the bolt is inserted. With reference to FIGS. 5 and 6, the end plate 14 in the present embodiment is formed of a material having magnetism. For example, the end plate 14 is formed of a material containing iron as a main component, such as carbon steel.

The end plate 14 includes the cutout portion 14a as a retraction portion formed in a surface being in contact with the rotor core 12. The retraction portion has a shape in which a space is formed on the side of an end face 13a of the magnet 13. The retraction portion has a shape in which a surface of the end plate 14 is away from the end face 13a of the magnet 13. The retraction portion is formed in at least a region among regions facing the magnets 13. In the first rotor 1, the cutout portion 14a is formed in an outer circumferential portion in a radial direction of the end plate 14. In particular, the cutout portion 14a is formed entirely in the outer circumferential portion. The cutout portion 14a is formed so as to extend along the circumferential direction of the end plate 14.

In the present embodiment, the length of the magnet 13 is slightly shorter than the length of the rotor core 12 in the direction in which the rotation axis 51 extends. The end plate 14 presses the rotor core 12 by coming into contact with an end face of the rotor core 12. When the end plates 14 come into contact with the magnet 13, the end plates 14 may press the magnet 13 in a direction in which the end plates 14 sandwich the magnet 13. As a result, the magnet 13 may crack. Thus, in the rotor 1 of the present embodiment, the magnet 13 is formed short so as not to be pressed by the end plates 14.

The first rotor 1 is formed such that the length in the radial direction of the cutout portion 14a is shorter than the maximum thickness in the radial direction of the magnet 13. The end plate 14 includes a support portion 14b formed so as to face the magnet 13. The support portion 14b is close to the end face 13a of the magnet 13. The support portion 14b is formed so as to support the magnet 13 by coming into contact with the magnet 13 when the magnet 13 moves in the direction in which the rotation axis 51 extends. The support portion 14b is constituted in a region around the cutout portion 14a. In the first rotor 1, the support portion 14b is constituted in a region radially inside the cutout portion 14a. In the present embodiment, the magnet 13 is fixed to the rotor core 12 by an adhesive. A slight gap is formed between the support portion 14b of the end plate 14 and the end face 13a of the magnet 13.

The end plate 14 in the present embodiment is formed of a material having magnetism. Thus, it is unnecessary to use a precious material such as stainless steel or aluminum. On the other hand, when the end face 13a of the magnet 13 approaches or comes into contact with the end plate 14 having magnetism by large area, magnetic flux of the magnet 13 may leak. That is, a loop of a line of magnetic force passing through the inside of the end plate 14 may be formed by one magnet 13.

In the first rotor 1 of the present embodiment, the cutout portion 14a as the retraction portion is formed such that a space is generated between the magnet 13 and the end plate 14. The surface of the end plate 14 can be away from the end face 13a of the magnet 13 by forming the cutout portion 14a. Thus, it is possible to suppress formation of a loop of a line of magnetic force by one magnet. An electric motor including the rotor of the present embodiment can suppress a decrease in torque due to leakage of magnetic flux.

Accordingly, in the rotor of the present embodiment, leakage of magnetic flux can be suppressed while avoiding use of a valuable material. As a result, it is possible to provide a rotor and an electric motor that are inexpensive and excellent in performance.

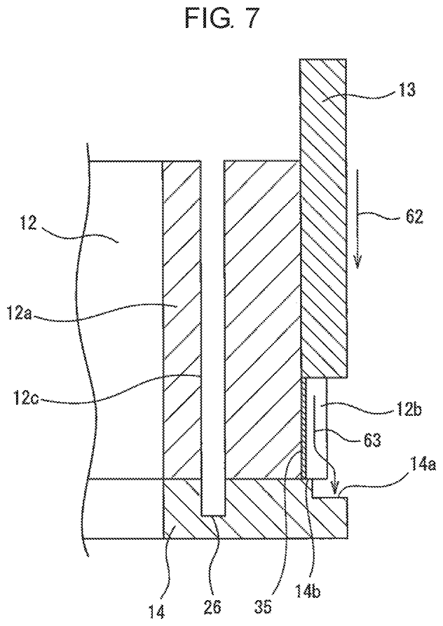

FIG. 7 illustrates an enlarged cross-sectional view of the rotor core, the magnet, and the end plate for explaining a method of manufacturing the first rotor of the present embodiment. A worker disposes the rotor core 12 on the one end plate 14. At this time, the rotor core 12 is disposed such that the through hole 12c formed in the rotor core 12 communicates with the hole 26 formed in the one end plate 14. The rotor core 12 and the end plate 14 are temporarily fixed by a jig such as a fixture.

Next, a worker applies an adhesive 35 to a region between the locking portions 12b of the rotor core 12. Next, a worker disposes the magnet 13 between the locking portions 12b. A worker inserts the magnet 13 between the locking portions 12b by moving the magnet 13 as indicated by an arrow 62. The adhesive 35 is disposed between the magnets 13 and the outer circumferential surface of the rotor core 12. An excess of the adhesive 35 is pushed out to the cutout portion 14a by the magnet 13 as indicated by an arrow 63. Subsequently, the other end plate 14 is disposed, and the two end plates 14 can be fixed to the rotor core 12 by the bolt 31.

In the related art, since no cutout portion 14a is formed in the end plate 14, an excess of an adhesive overflows to the outside from a boundary portion between a magnet and an end plate. A worker needs to wipe off the adhesive overflowing from the boundary portion between the magnet and the end plate. On the other hand, in the first rotor in the present embodiment, an excess of the adhesive 35 moves to the cutout portion 14a as indicated by the arrow 63. Overflow of an excess of the adhesive 35 to the outside can be avoided. Thus, it becomes unnecessary to wipe off an excess of the adhesive. Alternatively, it becomes unnecessary to scrape off an excess of the adhesive after drying the adhesive.

Note that in accordance with the adhesive 35 disposed by a large amount, when the magnet 13 is inserted between the locking portions 12b, the adhesive 35 may protrude radially outward from the cutout portion 14a. In accordance with this case, a worker may wipe or scrape off the adhesive 35. Similarly, in accordance with this case, since the cutout portion 14a is formed, an amount of the adhesive protruding from the cutout portion 14a is reduced, and work of a worker can be reduced.

With reference to FIG. 6, the end plate 14 in the present embodiment includes the support portion 14b formed in a region radially inside the cutout portion 14a and facing the magnet 13. When the fixing of the magnet 13 by the adhesive 35 is released, the magnet 13 moves along the rotation axis 51. The support portion 14b is formed so as to support the magnet 13 by coming into contact with the magnet 13 when the magnet 13 moves. Thus, even when the fixing of the magnet 13 by the adhesive 35 is released, movement in the direction of the rotation axis 51 of the magnet 13 can be suppressed. In particular, protrusion of the magnet 13 from the end face of the rotor core 12 can be suppressed.

Further, although the magnet 13 in the present embodiment is fixed to the rotor core 12 by the adhesive 35, the embodiment is not limited to this form. The magnet 13 may not be fixed to the rotor core 12 by the adhesive 35. The magnet 13 may be disposed so as to slightly move in the direction in which the rotation axis 51 extends. Similarly, in accordance with this case, since the end plate 14 includes the support portion 14b, movement and protrusion of the magnet 13 from the end face of the rotor core 12 can be suppressed. Note that although the end face 13a of the magnet 13 in the present embodiment is slightly away from the support portion 14b of the end plate 14, the embodiment is not limited to this form. The end face 13a of the magnet 13 may be in contact with the support portion 14b of the end plate 14 by fastening the end plate 14 with the bolt 31.

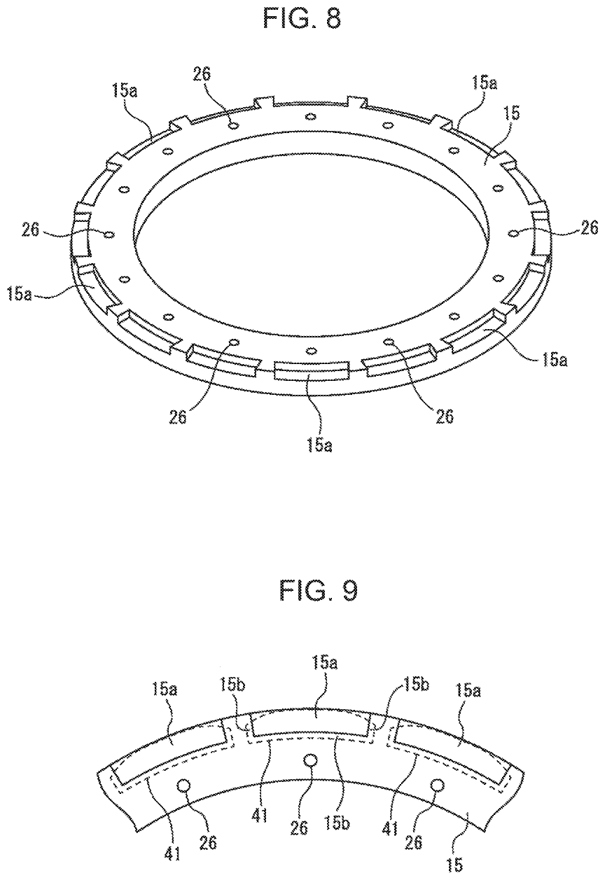

FIG. 8 illustrates an enlarged perspective view of an end plate of a second rotor in the present embodiment. In the end plate 14 of the first rotor 1, the cutout portion 14a is formed entirely in the outer circumferential portion, but the embodiment is not limited to this form. The cutout portion 14a as the retraction portion may be formed in at least a part of a region where the magnet 13 is disposed. The second rotor includes two end plates 15. Each of the end plates 15 includes a plurality of cutout portions 15a. The cutout portions 15a are formed along the circumferential direction in an outer circumferential portion of the end plate 15.

FIG. 9 illustrates an enlarged plan view of the end plate of the second rotor in the present embodiment. In FIG. 9, a region 41 in which a magnet 13 is disposed is indicated by a broken line. With reference to FIGS. 8 and 9, each of the cutout portions 15a is formed corresponding to the region where the magnet 13 is disposed. The circumferential length of the cutout portion 15a is shorter than the circumferential length of the magnet 13. A support portion 15b facing the magnet 13 is formed in a region around the cutout portion 15a. The circumferential length of the cutout portion 15a may be the same as the circumferential length of the magnet 13. Alternatively, the circumferential length of the cutout portion 15a may be longer than the circumferential length of the magnet 13.

Similarly, in the second rotor, leakage of magnetic flux can be suppressed by a space formed by the cutout portion 15a. Other configurations, operations, and effects are similar to those of the first rotor, and thus description of those will not be repeated here.

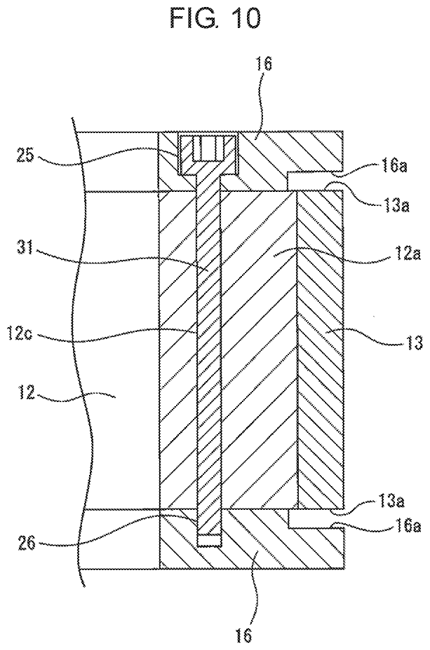

FIG. 10 illustrates an enlarged cross-sectional view of a rotor core, a magnet, and an end plate of a third rotor in the present embodiment. The third rotor includes two end plates 16 disposed on both sides of a rotor core 12. A magnet 13 is fixed to the rotor core 12 by an adhesive. A cutout portion 16a is formed in an outer circumferential portion of each of the end plates 16. The length in the radial direction of the cutout portion 16a is longer than the length in the radial direction of the magnet 13. In the end plate 16, a support portion facing an end face 13a of the magnet 13 is not formed. The magnet 13 is disposed inside a region where the cutout portion 16a is formed. The cutout portion 16a is formed such that the end face 13a of the magnet 13 is entirely away from a surface of the end plate 16.

The configuration of the cutout portion 16a of the third rotor is adopted, and thus, a space formed on the side of the end face 13a of the magnet 13 increases, and an effect of suppressing leakage of magnetic flux of the magnet 13 increases. Other configurations, operations, and effects of the third rotor are similar to those of the first rotor and the second rotor, and thus description of those will not be repeated here.

In the first rotor, the second rotor, and the third rotor described above, the cutout portion is formed in the outer circumferential portion of the end plate, but the embodiment is not limited to this form. The cutout portion can be formed at an end portion in the radial direction of the end plate. For example, the cutout portion may be formed in an inner circumferential portion of the end plate. That is, the cutout portion may be formed from the inner circumferential surface of the end plate toward the outside in the radial direction.

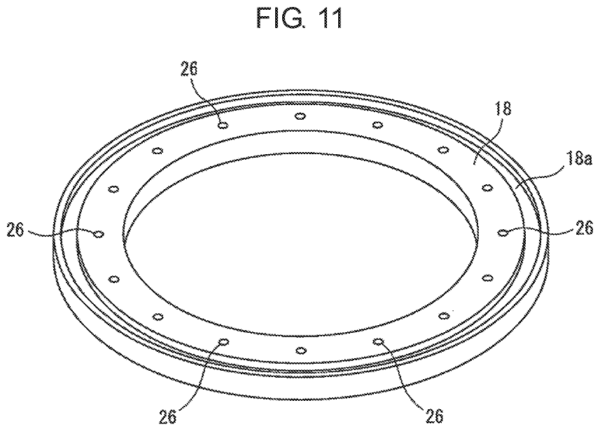

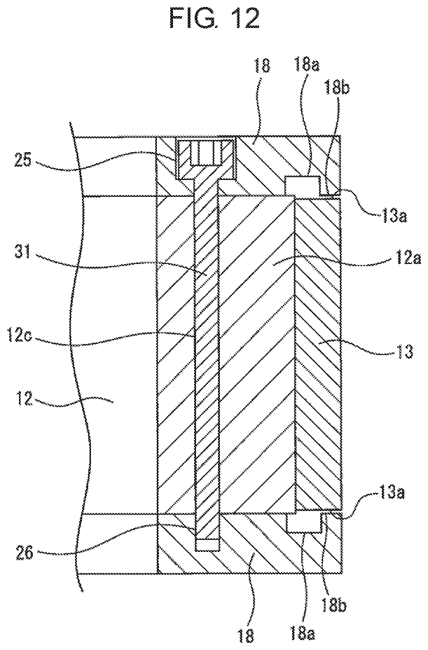

FIG. 11 illustrates a perspective view of an end plate of a fourth rotor in the present embodiment. FIG. 12 illustrates an enlarged cross-sectional view of a rotor core, an end plate, and a magnet of the fourth rotor in the present embodiment. With reference to FIGS. 11 and 12, the fourth rotor includes two end plates 18. Each of the end plates 18 includes a recess 18a as a retraction portion having a shape in which a surface of the end plate 18 is away from an end face 13a of a magnet 13. The recess 18a is a part recessed from a part of the end plate 18 being in contact with a rotor core 12. The recess 18a is formed in a region where the end face 13a of the magnet 13 is disposed. The recess 18a extends along the circumferential direction. The recess 18a is formed such that at least a part of a region of the end face 13a of the magnet 13 does not come into contact with the end plate 18. Alternatively, the recess 18a is formed such that at least a part of a region of the end face 13a of the magnet 13 does not approach the end plate 18. In the fourth rotor of the present embodiment, the recess 18a is constituted by a groove portion that makes one round in the circumferential direction.

FIG. 11 illustrates the one end plate 18 in which a hole 26 is formed. As for the other end plate 18 in which an insertion portion 25 is formed, the recess 18a similar to that of the one end plate 18 is formed in a surface being in contact with the rotor core 12. Similarly, in the fourth rotor, since at least a part of the end face 13a of the magnet 13 is in contact with a space formed by the recess 18a, leakage of magnetic flux can be suppressed.

Additionally, in a process of manufacturing the rotor, when the magnet is disposed between locking portions, an excess of an adhesive is pushed out to the inside of the recess 18a. Since the recess 18a does not communicate with an outer circumferential surface, it is possible to suppress protrusion of an excess of the adhesive out of the rotor. Thus, work of wiping or scraping off an excess of the adhesive is reduced.

The end plate 18 of the present embodiment includes a support portion 18b formed so as to face the end face 13a of the magnet 13. The support portion 18b is constituted in a region around the recess 18a. Since the end plate 18 includes the support portion 18b, movement of the magnet 13 in the direction in which the rotation axis 51 extends can be suppressed. In particular, when the magnet 13 is not fixed by an adhesive, protrusion of the magnet 13 from an end face of the rotor core 12 can be suppressed.

Note that although the fourth rotor includes the support portion 18b facing the end face of the magnet 13, the embodiment is not limited to this form. In the end plate, a recess may be formed so as not to include a support portion. For example, the end face of the magnet may entirely be formed so as to be disposed inside a region of the recess. That is, the recess may be formed large such that the end face of the magnet is disposed inside the region of the recess.

Other configurations, operations, and effects of the fourth rotor are similar to those of the first rotor to the third rotor, and thus description of those will not be repeated here.

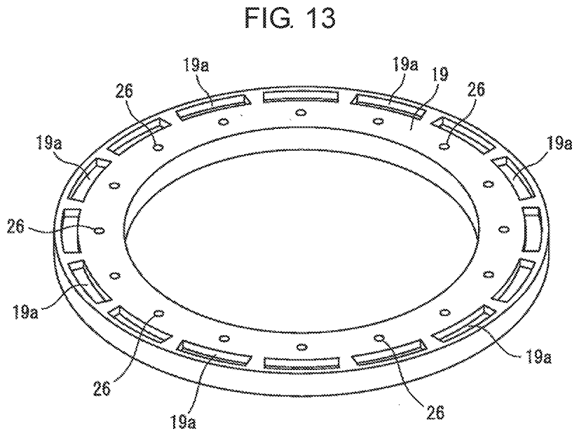

FIG. 13 illustrates a perspective view of an end plate of a fifth rotor in the present embodiment. In an end plate 19 of the fifth rotor, a plurality of recesses 19a are formed as retraction portions. The plurality of recesses 19a are formed apart from each other so as to correspond to regions of magnets 13. The recesses 19a are formed along the circumferential direction. FIG. 13 illustrates one end plate 19 including a hole 26. The other end plate 19 including an insertion portion 25 includes the recesses 19a similar to those of the one end plate 19.

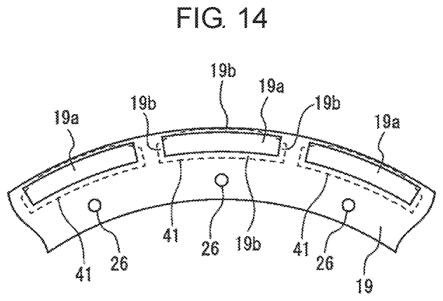

FIG. 14 illustrates a plan view of the end plate for explaining regions where the plurality of recesses are formed and regions where the magnets are disposed in the fifth rotor. In FIG. 14, a region 41 in which the magnet 13 is disposed is indicated by a broken line. Each of the recesses 19a is formed so as to correspond to the region 41 where the magnet is disposed. Additionally, in this example, one recess 19a is formed with respect to one magnet 13.

The length in the radial direction of the recess 19a is formed so as to be shorter than the maximum thickness in the radial direction of the magnet 13. The circumferential length of the recess 19a is formed so as to be shorter than the circumferential length of the magnet 13. A support portion 19b of the end plate 19 is constituted, among the regions 41 in which the magnets are disposed, in a part on a side in the circumferential direction of the recess 19a and a part on a side in the radial direction of the recess 19a. Since the end plate 19 includes the support portion 19b, movement of the magnet in the direction in which the rotation axis 51 extends can be suppressed.

Other configurations, operations, and effects of the fifth rotor are similar to those of the first rotor to the fourth rotor, and thus description of those will not be repeated here.

In the fourth rotor and the fifth rotor of the present embodiment, the recess extending in the circumferential direction is formed in the end plate, but the embodiment is not limited to this form. The recess can be formed in at least a region among regions facing the magnet. For example, a dot-like recess may be formed in the region where the magnet is disposed.

In the end plate of the above-described embodiment, one of the recess and the cutout portion is formed as the retraction portion, but the embodiment is not limited to this form. At least one of the cutout portion and the recess can be formed in the end plate. For example, the cutout portion and the recess may be formed alternately along the circumferential direction in one end plate. Alternatively, the cutout portion may be formed in the one end plate, and the recess may be formed in the other end plate.

The rotor in the present embodiment is a rotor of a surface magnet type in which a plurality of permanent magnets are disposed in the circumferential direction in an outer circumferential surface of a rotor core, but the embodiment is not limited to this form. The end plate including the retraction portion of the present embodiment can also be disposed in a rotor in which a permanent magnet is embedded in a rotor core.

According to an aspect of the present disclosure, it is possible to provide a rotor that includes an end plate having magnetism and that suppresses leakage of magnetic flux, and an electric motor including the rotor.

The above-described embodiments can be combined as appropriate. In each of the above-described figures, the same or equivalent parts are denoted by the same reference signs. Note that the above-described embodiments are examples and do not limit the invention. Additionally, the embodiments include modifications of the embodiments described in the claims.

1. A rotor comprising:
a rotor core rotating about a rotation axis;
a plurality of magnets supported by the rotor core; and
end plates disposed to sandwich end faces on both sides of the rotor core; wherein
each of the end plates is formed of a material having magnetism,
the end plate includes a retraction portion that is formed in at least a region among regions facing the plurality of magnets and that has a shape in which a surface of the end plate is away from an end face of each of the plurality of magnets, and
the retraction portion includes at least one of a cutout portion formed at an end portion in a radial direction of the end plate and a recess recessed from a part of the end plate being in contact with the rotor core.

2. The rotor according to claim 1, wherein
the magnet is fixed to the rotor core by an adhesive.

3. The rotor according to claim 1, wherein
the end plate includes a support portion facing the magnet and configured to support the magnet when the magnet moves in a direction in which the rotation axis extends, and
the support portion is constituted in a region around the retraction portion.

4. The rotor according to claim 1, wherein
the retraction portion has a shape extending along a circumferential direction.

5. An electric motor comprising:
the rotor according to claim 1; and
a stator in which the rotor is disposed.
